(19) United States
(12) Patent Application Publication
(10) Pub. No.: US 2023/0278270 A1
(43) Pub. Date: Sep. 7, 2023

(54) INJECTION MOLDING MACHINE FOR FOAM MOLDING AND METHOD FOR MOLDING FOAM MOLDED PRODUCT

(71) Applicant: THE JAPAN STEEL WORKS, LTD., Tokyo (JP)

(72) Inventors: Akihiro NAITO, Tokyo (JP); Takuya Yufu, Tokyo (JP)

(73) Assignee: THE JAPAN STEEL WORKS, LTD., Tokyo (JP)

(21) Appl. No.: 18/171,138

(22) Filed: Feb. 17, 2023

(30) Foreign Application Priority Data
Mar. 1, 2022 (JP) 2022-031201

(51) Int. Cl. B29C 45/50; B29C 45/77; B29C 45/74; B29C 45/17

(52) U.S. Cl. CPC B29C 45/50; B29C 45/77; B29C 45/74; B29C 45/1704; B29C 45/1732; B29C 2945/76006; B29C 2945/76193; B29C 2945/76839

(57) ABSTRACT

An injection molding machine for foam molding includes a heating cylinder having a gas injection port, a screw which is drivable in the heating cylinder, a gas supply device configured to supply a gas to the gas injection port, the gas supply device including a valve mechanism in a gas flow path, and a control device. The control device is configured to control the valve mechanism to close the valve mechanism at least once in a molding cycle, and keep the valve mechanism open at least in a measuring step.

This application is based on and claims priority under 35 USC 119 from Japanese Patent Application No. 2022-031201 filed on Mar. 1, 2022, the contents of which are incorporated herein by reference.

### TECHNICAL FIELD

The present disclosure relates to an injection molding machine for foam molding for molding a foam molded product by injecting an inert gas into an injection material, and a method for molding the foam molded product.

### BACKGROUND

An injection molding machine for foam molding for obtaining a foam molded product using a physical foaming agent, that is, a gas, is generally configured as follows, for example, as disclosed in JP2014-200937A. That is, an injection device of the injection molding machine includes a heating cylinder and a screw. An inside of the heating cylinder is divided into a plurality of sections according to a shape of the screw. The inside of the heating cylinder includes, from upstream to downstream, a first compression and measurement section, a starvation section, and a second compression and measurement section. The heating cylinder is provided with a gas injection port so as to correspond to the starvation section. The gas is supplied by a gas supply device including a gas cylinder or the like. A gas flow path of the gas supply device is coupled to the gas injection port.

A resin is fed from upstream to downstream in the heating cylinder by the screw and is melted. The resin is kneaded in the first compression and measurement section. Then, a pressure of the resin decreases in the starvation section, and a gas such as nitrogen and carbon dioxide is injected. The resin into which the gas is injected is kneaded and compressed in the second compression and measurement section. The resin is measured and is injected into a mold to obtain a foam molded product.

### SUMMARY

In the injection molding machine for foam molding, a so-called gas leakage may occur in which, after a measuring step is completed, a part of gas injected into the heating cylinder flows back through the heating cylinder and leaks from upstream of the heating cylinder.

Other problems and novel features will become apparent from description of the present description and the accompanying drawings.

Illustrative aspects of the present disclosure relate to an injection molding machine having a following configuration. That is, the injection molding machine includes: a heating cylinder provided with a gas injection port; a screw; a gas supply device configured to supply a gas to the gas injection port; and a control device. A valve mechanism is provided in a gas flow path of the gas supply device. The control device is configured to control the valve mechanism to be closed at least once in a molding cycle, and to be kept in an open state at least in a measuring step.

According to the present disclosure, it is possible to prevent gas leakage in which the gas flows backward in the heating cylinder by opening and closing the gas flow path to the gas injection port.

### BRIEF DESCRIPTION OF DRAWINGS

FIG. 1 is a front view showing an injection molding machine according to the present illustrative embodiment.

FIG. 2 is a front cross-sectional view showing an injection device and a gas supply device according to the present illustrative embodiment.

FIG. 3A is a time chart showing a method for molding a foam molded product performed in the injection molding machine according to the present illustrative embodiment.

FIG. 3B is a time chart showing another method for molding a foam molded product performed in the injection molding machine according to the present illustrative embodiment.

FIG. 4 is a graph showing changes in a screw position, a screw rotation speed, a resin pressure, and a gas pressure when a molding cycle is performed by constantly supplying a gas to a gas injection port in the injection molding machine according to the present illustrative embodiment.

FIG. 5A is a front cross-sectional view showing an injection device and the gas supply device according to a second illustrative embodiment of the present illustrative embodiment.

FIG. 5B is a front cross-sectional view showing an injection device and a gas supply device according to a third illustrative embodiment of the present illustrative embodiment.

### DETAILED DESCRIPTION

Hereinafter, specific illustrative embodiments will be described in detail with reference to the drawings. The present disclosure is not limited to the following illustrative embodiments. In order to clarify description, following description and drawings are simplified as appropriate. In the drawings, the same elements are denoted by the same reference signs, and repeated description thereof is omitted as necessary. Hatching may be omitted to avoid complicating the drawings.

The present illustrative embodiment will be described.

{Injection Molding Machine}

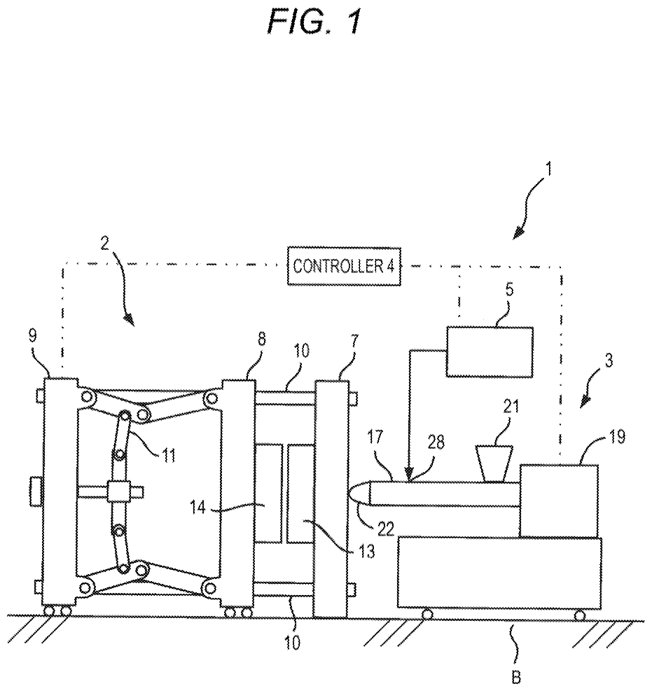

As shown in FIG. 1, an injection molding machine 1 according to the present illustrative embodiment is schematically implemented by a mold clamping device 2 provided on a bed B, an injection device 3, a gas supply device 5 which supplies a gas to the injection device 3, and a controller 4 which controls these devices. The mold clamping device 2 may be implemented by a direct pressure type, but in the present illustrative embodiment, the mold clamping device 2 is implemented by a toggle type. That is, the mold clamping device 2 includes a fixed platen 7, a movable platen 8, a mold clamping housing 9, tie bars 10, 10, . . . coupling the mold clamping housing 9 and the fixed platen 7, and a toggle mechanism 11. The fixed platen 7 and the movable platen 8 are provided with molds 13 and 14. Therefore, when the toggle mechanism 11 is driven, the molds 13 and 14 are mold-clamped.

{Injection Device}

The injection device 3 according to the present illustrative embodiment is supplied with a gas by the gas supply device 5 (which will be described later), and a resin into which the gas is kneaded and mixed, that is, a resin containing a physical foaming agent is measured. Therefore, when the mixture is injected, a foam molded product is obtained. That is, the injection device 3 for foam molding is provided.

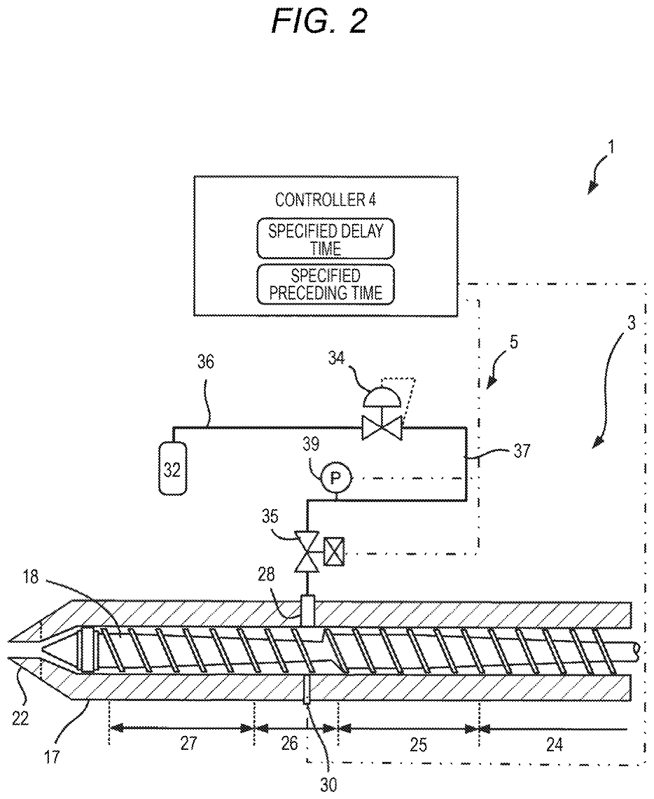

The injection device 3 includes a heating cylinder 17, a screw 18 housed in the heating cylinder 17 as shown in FIG. 2, and a screw drive device 19 (see FIG. 1) which supports the heating cylinder 17 and drives the screw 18. A hopper 21 is provided upstream of the heating cylinder 17, and an injection nozzle 22 is provided at a tip end downstream of the heating cylinder 17.

As shown in FIG. 2, in the screw 18, groove depths of a flight change from upstream toward downstream. An inside of the heating cylinder 17 is divided into a plurality of sections. That is, from upstream, the resin is divided into a supply section 24 in which the resin is supplied and melted, a first compression and measurement section 25 in which the melted resin is compressed, a starvation section 26 in which a pressure of the resin decreases, and a second compression and measurement section 27. A gas injection port 28 is provided in the heating cylinder 17, corresponding to the starvation section 26, and a gas is injected into the molten resin. The resin into which the gas is thus injected is kneaded in the second compression and measurement section 27.

A resin pressure sensor 30 is embedded in the heating cylinder 17 in association with the gas injection port 28. That is, the resin pressure sensor 30 is embedded in the vicinity of the gas injection port 28 and is configured to detect a resin pressure in the starvation section 26. The detected resin pressure is sent to the controller 4.

{Gas Supply Device}

The gas supply device 5 according to the present illustrative embodiment includes a gas cylinder 32 as a gas supply source, a pressure reducing valve 34, and an on-off valve 35. A primary gas pipe 36 is coupled to the gas cylinder 32, and a relatively high-pressure primary gas is supplied to the primary gas pipe 36. The pressure reducing valve 34 is coupled between the primary gas pipe 36 and the secondary gas pipe 37. The pressure reducing valve 34 is configured to reduce a pressure of the gas having a primary pressure to a secondary pressure suitable for supplying the gas to the resin. The on-off valve 35 is provided in the secondary gas pipe 37. The on-off valve 35 is coupled to the gas injection port 28. The on-off valve 35 is configured to open and close a gas flow path of the secondary gas pipe 37. When the gas flow path is opened, the gas having the secondary pressure is supplied from the gas injection port 28 into the heating cylinder 17. When the gas flow path is closed, the supply of the gas is stopped.

In the gas supply device 5, a gas pressure gauge 39 is provided in the secondary gas pipe 37 and is configured to detect the secondary pressure of the gas. That is, the pressure of the gas supplied from the gas injection port 28 is substantially detected. The gas pressure gauge 39 and the on-off valve 35 are coupled to the controller 4. The secondary pressure is transmitted to the controller 4, and the controller 4 is configured to control opening and closing of the on-off valve 35. As will be described next, in the present illustrative embodiment, the on-off valve 35 is controlled so as to be closed at least once in a molding cycle and to be in an open state in a measuring step.

{Method for Molding Foam Molded Product}

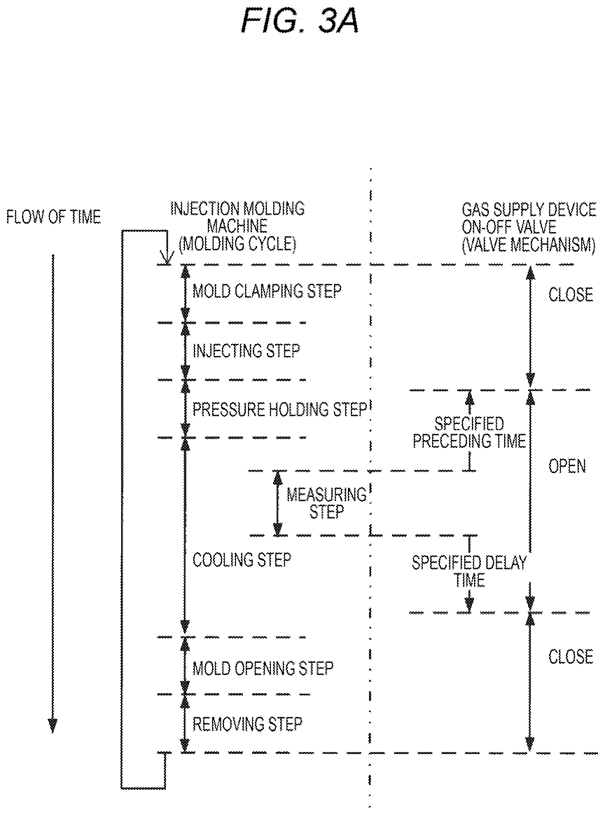

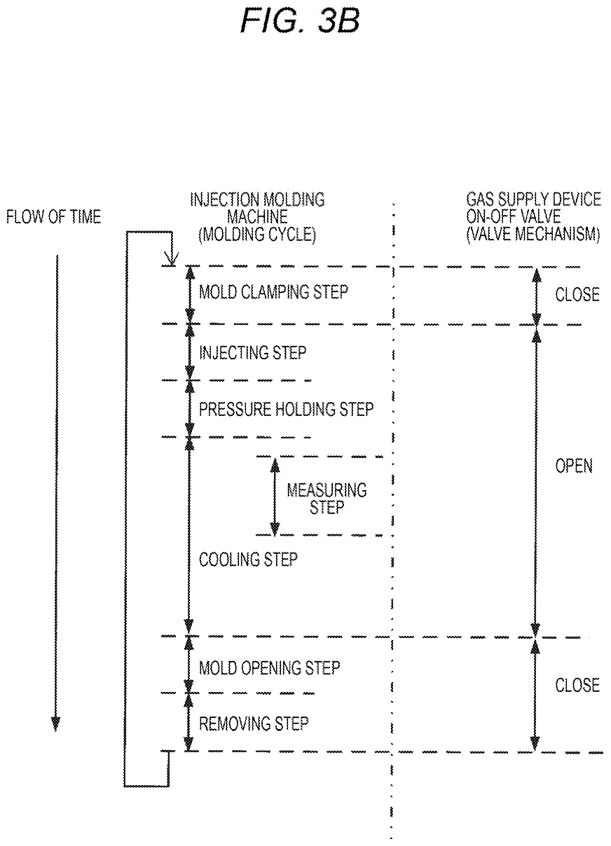

A method for molding a foam molded product, which is performed by the injection molding machine 1 according to the present illustrative embodiment, will be described. In FIG. 3A, the molding cycle performed in the injection molding machine 1 (see FIG. 1) and an operation of the on-off valve 35, that is, a valve mechanism of the gas supply device 5 according to the present illustrative embodiment are shown in parallel. Opening and closing of the on-off valve 35 is performed at predetermined timings in synchronization with the molding cycle. However, the operation of the on-off valve 35 is not described here, and first, only the molding cycle performed in the injection molding machine 1 will be described.

In the molding cycle performed in the injection molding machine 1, a mold clamping step is first performed. That is, the mold clamping device 2 (see FIG. 1) is driven to mold-clamp the molds 13 and 14. Next, the screw 18 is driven in an axial direction to perform an injecting step, and the resin is injected into the molds 13 and 14. Incidentally, it is assumed that the heating cylinder 17 (see FIG. 2) has measured the resin in advance in which the gas is melted. Therefore, the resin is foamed in the molds 13 and 14, and a foam molded product is obtained. As shown in FIG. 3A, a pressure holding step is performed. That is, a resin pressure is applied by the screw 18.

A cooling step is performed to wait for solidification of the resin filled in the molds 13 and 14. At the same time as start of the cooling step or after the cooling step, the measuring step is performed. That is, the screw 18 is rotated to melt the resin and to perform a measurement. At this time, since the gas is supplied from the gas injection port 28 (see FIG. 2), the resin and the gas are kneaded. When a predetermined amount of the resin is measured, the measuring step is completed. Since the foam molded product takes time to cool, the cooling step is generally continued for a predetermined time when the measuring step is completed. Incidentally, in the case of the foam molded product requiring a short time for cooling, the cooling step may have already been completed when the measuring step is completed. After the cooling step is completed, a mold opening step is performed. That is, the mold clamping device 2 is driven to mold-open the molds 13 and 14. A removing step of removing the molded product is performed. A next molding cycle is started. That is, the processing returns to the mold clamping step.

Next, control over the on-off valve 35 of the gas supply device 5 will be described. The on-off valve 35 is operated in synchronization with the molding cycle of the injection molding machine 1 described above. Specifically, as shown in FIG. 3A, the on-off valve 35 is opened earlier than the measuring step by a specified preceding time. After the measuring step is completed, the on-off valve 35 is closed with a delay of a specified delay time. The specified preceding time and the specified delay time are set in advance by an engineer, and are stored in the controller 4 as shown in FIG. 2. The controller 4 controls to open and close the on-off valve 35 based on these setting values, that is, the specified preceding time and the specified delay time, and a timing of the measuring step in the molding cycle.

When the on-off valve 35 is opened, the gas is inevitably supplied from the gas injection port 28 (see FIG. 2) into the heating cylinder 17, so that the gas and the resin are appropriately kneaded. Since the gas is consumed in the measuring step and the secondary pressure decreases, the gas injection port 28 is opened earlier than the measuring step by a specified preceding time so that the gas is stably supplied. Since a gas pressure slightly decreases immediately after the measuring step is completed, the on-off valve 35 is left open for the specified delay time after the measuring step is completed to wait for the gas pressure to increase. When the on-off valve 35 is closed, the supply of the gas to the gas injection port 28 is stopped, so that it is possible to reliably prevent so-called gas leakage in which the gas flows upstream in the heating cylinder 17 (see FIG. 2). Since the on-off valve 35 is closed once in the molding cycle, venting up, in which the resin enters from the gas injection port 28, is also prevented.

{Other Illustrative embodiments of Method for Molding Foam Molded Product}

Various modifications can be made to the method for molding a foam molded product. For example, a timing at which the on-off valve 35 is opened has been described as being earlier than the measuring step by the specified preceding time. However, a timing at which the on-off valve 35 is opened may be used as a start timing of the measuring step. A timing at which the on-off valve 35 is closed has been described as being a timing delayed by the specified delay time from completion of the measuring step. However, the on-off valve 35 may be closed at a timing of the completion of the measuring step. Further, the timings of opening and closing the on-off valve 35 may be synchronized with the steps themselves in the molding cycle. FIG. 3B shows such an illustrative embodiment. That is, the on-off valve 35 is opened at the same time as the injecting step, which is one of the steps in the molding cycle, and is closed when the cooling step is completed. When the opening and closing of the on-off valve 35 is operated in synchronization with the steps in the molding cycle in this way, substantially a similar effect can be obtained.

{Method for Determining Specified Delay Time, and the Like}

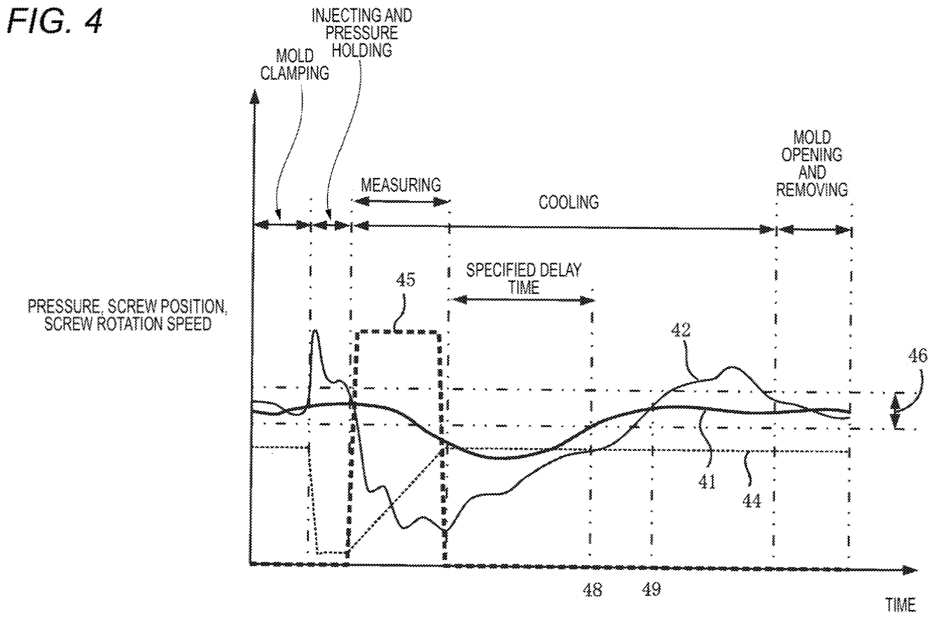

The specified preceding time and the specified delay time have been described as being set in advance in the controller 4 by an engineer. These times or the steps synchronized with the opening and closing of the on-off valve 35 may be freely determined by an engineer, or may be determined by preliminary preparation in which the molding cycle is repeated in a state where the on-off valve 35 is opened. This will be described. In the preliminary preparation, in the injection molding machine 1 according to the present illustrative embodiment shown in FIGS. 1 and 2, the on-off valve 35 is in an open state and the state is maintained. The molding cycle is repeated several times in the injection molding machine 1. A change in the gas pressure and an average change in the resin pressure in the molding cycle are obtained. A graph of FIG. 4 shows thus-obtained average changes in the gas pressure 41 and the resin pressure 42. The graph also shows a screw position 44 and a rotation speed 45 of the screw 18.

Here, an appropriate range of the gas pressure is considered. FIG. 4 shows an appropriate range 46 of the gas pressure. The appropriate range can be determined as follows. For example, an upper limit of the gas pressure is set to a pressure for preventing the gas from being excessively supplied into the heating cylinder 17 and from flowing backward in the heating cylinder 17. A lower limit of the gas pressure is a gas pressure required to appropriately supply the gas, and is set to a gas pressure at which stable supply is difficult when the gas pressure is lower than the lower limit. As can be seen from the graph of FIG. 4, the gas pressure rapidly decreases in the measuring step and gradually increases after the measuring step is completed. That is, it takes time to recover the gas pressure. Therefore, a timing 48 at which the gas pressure returns to the appropriate range 46 is searched, a time after the completion of the measuring step is calculated, and the calculated time may be determined as the specified delay time.

On the other hand, it can be seen that the gas pressure does not increase so much in the injecting step and the pressure holding step. That is, even when the on-off valve 35 (see FIG. 2) is kept open at all times, no rapid increase in the gas pressure occurs in the injecting step and the pressure holding step. Therefore, it is possible to determine to open the on-off valve 35 in conjunction with the injecting step. Accordingly, it is possible to prepare for the gas pressure decrease in advance before a rapid decrease in the gas pressure occurs in the measuring step.

As has been described above, the timings of opening and closing the on-off valve 35 and the step synchronized with the opening and closing of the on-off valve 35 can be determined based on a fluctuation in the gas pressure in the molding cycle. Alternatively, they may be determined based on a fluctuation in the resin pressure. For example, in FIG. 4, the resin pressure is higher than the gas pressure after a timing denoted by reference sign 49. Accordingly, there may be a risk of occurrence of venting up. Therefore, it is possible to determine to close the on-off valve 35 at the timing denoted by the reference sign 49.

Incidentally, the graph of the gas pressure 41 and the resin pressure 42 shown in FIG. 4 may greatly vary depending on a configuration of the injection molding machine 1, a molded product or a resin to be used. For example, when the secondary gas pipe 37 (see FIG. 2) is relatively long, it takes time for the gas pressure 41 to increase when the gas pressure 41 decreases. Alternatively, in a case the molded product is relatively small, an amount of resin to be injected is small, so that a fluctuation in the gas pressure 41 and a fluctuation in the resin pressure 42 are also relatively small. Therefore, in determination of the specified delay time or the like or in determination of the step in which the on-off valve 35 is opened and closed, repeated molding cycles are to be performed for the injection molding machine 1 to be actually used, the molded product to be actually molded, and the resin to be used, to examine changes in the gas pressure 41 and in the resin pressure 42.

{Injection Molding Machine According to Second Illustrative Embodiment}

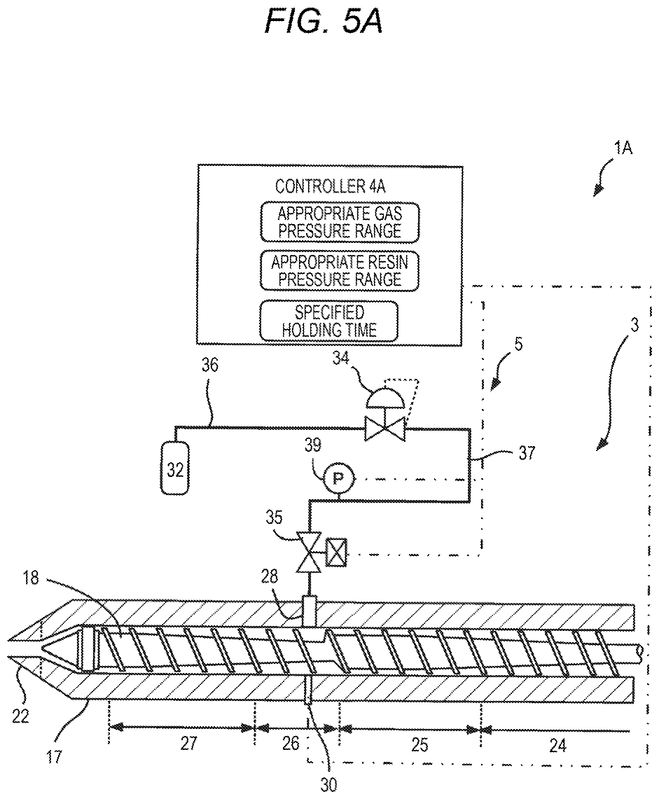

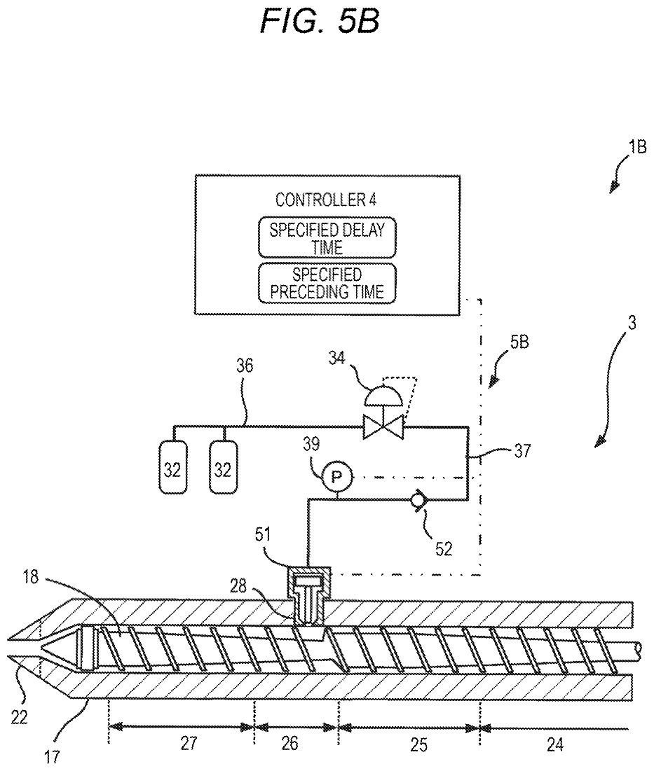

In the above description, it is assumed that the timing at which the on-off valve 35 is closed is after a specified delay time from the completion of the measuring step, or is synchronized with steps such as the measuring step and the cooling step. However, the on-off valve 35 may be closed by determining a timing for each molding cycle based on the gas pressure measured by the gas pressure gauge 39 or based on the resin pressure measured by the resin pressure sensor 30. FIG. 5A shows an injection molding machine 1A according to a second illustrative embodiment in which the on-off valve 35 is thus operated.

In the injection molding machine 1A according to the second illustrative embodiment, three setting values are stored in a controller 4A. That is, an appropriate gas pressure range, an appropriate resin pressure range, and a specified holding time are stored. The injection molding machine 1A according to the second illustrative embodiment can determine a closing timing of the on-off valve 35 from two methods. A first method is a method of determination based on the gas pressure. When the measuring step is completed in the molding cycle, the controller 4A monitors the gas pressure detected by the gas pressure gauge 39. When the gas pressure reaches the appropriate gas pressure range, the on-off valve 35 is closed. Alternatively, the on-off valve 35 is closed when the gas pressure reaches the appropriate gas pressure range and when the specified holding time elapses.

A second method is a method of determination based on the resin pressure. When the measuring step is completed in the molding cycle, the controller 4A monitors the resin pressure detected by the resin pressure sensor 30. When the resin pressure reaches the appropriate resin pressure range, the on-off valve 35 is closed. Alternatively, the on-off valve 35 is closed when the resin pressure reaches the appropriate resin pressure range and when the specified holding time elapses.

The timing at which the on-off valve 35 is opened has been explained as being, for example, earlier than the start of the measuring step by the specified preceding time. The specified preceding time may be adjusted for each molding cycle. For example, the gas pressure or the resin pressure is detected at the start timing of the measuring step, and when the gas pressure or the resin pressure deviates from the appropriate range, the specified preceding time may be adjusted based on a magnitude of the deviation. For example, when the gas pressure does not reach the appropriate range at the start of the measuring step, the specified preceding time may be adjusted to be long in next and subsequent molding cycles so that the gas pressure falls within the appropriate range.

{Injection Molding Machine According to Third Illustrative Embodiment}

In the injection molding machine 1 according to the present illustrative embodiment, the apparatus itself may be modified. FIG. 5B shows an injection molding machine 1B according to a third illustrative embodiment. In this illustrative embodiment, a gas supply device 5B is modified. In the gas supply device 5B, the valve mechanism is first modified. That is, an injection valve 51 is adopted instead of the on-off valve. The injection valve 51 is embedded in the heating cylinder 17, and the injection valve 51 also serves as the gas injection port 28. The gas supply device 5B is also modified in that a check valve 52 is provided in the secondary gas pipe 37 and two gas cylinders 32, 32 are provided. Further, in the third illustrative embodiment, the heating cylinder 17 is not provided with a sensor for measuring the resin pressure. The injection molding machine 1B according to the third illustrative embodiment can also be used to implement the method for molding a foam molded product according to the present illustrative embodiment.

Although the invention made by the present inventors is specifically described based on the illustrative embodiments, it is needless to say that the present invention is not limited to the illustrative embodiments described above, and various modifications can be made without departing from the scope of the invention. For example, although the supply of the gas is controlled by the on-off valve 35 or the injection valve 51, the check valve may be controlled by a pressure difference between upstream and downstream of the check valve. In FIG. 5B, a supply pressure is decreased by operating the pressure reducing valve 34 after the specified delay time. Then, a pressure of a downstream side of the check valve 52, at which the gas injection port 28 (which may also be called as a gas supply port) is disposed, becomes high pressure, and a pressure on an upstream side of the check valve 52, at which the pressure reducing valve 34 is disposed, becomes low pressure. Accordingly, since the check valve 52 is closed by the pressure difference, it is possible to obtain substantially the same effect as when gas supply is stopped by the on-off valve 35 or the injection valve 51. When the gas supply is restarted, the pressure reducing valve 34 may be operated to return the supply pressure to an original pressure. A plurality of examples described above may be implemented in combination as appropriate.

What is claimed is:

1. An injection molding machine for foam molding, comprising:
a heating cylinder having a gas injection port;
a screw which is drivable in the heating cylinder;
a gas supply device configured to supply a gas to the gas injection port, the gas supply device comprising a valve mechanism in a gas flow path; and
a control device configured to control the valve mechanism to:
close the valve mechanism at least once in a molding cycle; and
keep the valve mechanism open at least in a measuring step.

2. The injection molding machine for foam molding according to claim 1, wherein the valve mechanism comprises an on-off valve or an injection valve.

3. The injection molding machine for foam molding according to claim 1, wherein the control device is configured to close the valve mechanism when a specified delay time elapses after completion of the measuring step.

4. The injection molding machine for foam molding according to claim 1, wherein the control device is configured to open the valve mechanism earlier than start of the measuring step by a specified preceding time.

5. The injection molding machine for foam molding according to claim 1, wherein the control device is configured to open the valve mechanism at a timing of an injecting step.

6. The injection molding machine for foam molding according to claim 3,
wherein the gas flow path of the gas supply device is provided with a gas pressure gauge configured to detect a gas pressure, and
wherein the specified delay time is determined in advance based on a tendency of a fluctuation in the gas pressure obtained by performing a molding cycle a plurality of times.

7. The injection molding machine for foam molding according to claim 4,
wherein the gas flow path of the gas supply device is provided with a gas pressure gauge configured to detect a gas pressure, and
wherein the specified preceding time is determined in advance based on a tendency of a fluctuation in the gas pressure obtained by performing a molding cycle a plurality of times.

8. The injection molding machine for foam molding according to claim 3,
wherein the heating cylinder comprises a resin pressure gauge configured to detect a resin pressure at the gas injection port, and
wherein the specified delay time is determined in advance based on a tendency of a fluctuation in the resin pressure obtained by performing a molding cycle a plurality of times.

9. The injection molding machine for foam molding according to claim 4,
wherein the heating cylinder comprises a resin pressure gauge that is configured to detect a resin pressure at the gas injection port, and
wherein the specified preceding time is determined in advance based on a tendency of a fluctuation in the resin pressure obtained by performing a molding cycle a plurality of times.

10. The injection molding machine for foam molding according to claim 1,
wherein the gas flow path of the gas supply device is provided with a gas pressure gauge configured to detect a gas pressure, and
wherein the control device is configured to close the valve mechanism when the detected gas pressure reaches an appropriate gas pressure range set in advance or after a specified holding time since the detected gas pressure reaches the appropriate gas pressure range.

11. The injection molding machine for foam molding according to claim 1,
wherein the gas injection port in the heating cylinder is provided with a resin pressure gauge configured to detect a resin pressure, and
wherein the control device is configured to close the valve mechanism when the detected resin pressure reaches an appropriate resin pressure range set in advance or after a specified holding time since the detected resin pressure reaches the appropriate resin pressure range.

12. The injection molding machine for foam molding according to claim 4,
wherein the gas flow path of the gas supply device is provided with a gas pressure gauge configured to detect a gas pressure, and
wherein the specified preceding time is adjusted for each molding cycle based on the gas pressure detected at the start of the measuring step.

13. A method for molding a foam molded product using an injection molding machine for foam molding,
the injection molding machine comprising:
a heating cylinder provided with a gas injection port;
a screw which is drivable in the heating cylinder;
a gas supply device configured to supply a gas to the gas injection port; and
a valve mechanism provided in a gas flow path of the gas supply device,
the method comprising:
controlling the valve mechanism to:
close the valve mechanism at least once in a molding cycle; and
keep the valve mechanism open to supply the gas to a resin in the heating cylinder at least in a measuring step.

14. The method for molding a foam molded product according to claim 13, wherein the closing of the valve mechanism is performed when a specified delay time elapses after completion of the measuring step.

15. The method for molding a foam molded product according to claim 13, wherein an opening operation of the valve mechanism is performed at a timing earlier than start of the measuring step by a specified preceding time.

16. The method for molding a foam molded product according to claim 13, wherein an opening operation of the valve mechanism is performed in an injecting step.

17. The method for molding a foam molded product according to claim 14,
wherein the gas flow path of the gas supply device is provided with a gas pressure gauge configured to detect a gas pressure, and
wherein the method further comprises determining the specified delay time in advance based on a tendency of a fluctuation in the gas pressure obtained by performing a molding cycle a plurality of times.

18. The method for molding a foam molded product according to claim 15,
wherein the gas flow path of the gas supply device is provided with a gas pressure gauge configured to detect a gas pressure, and
wherein the method further comprises determining the specified preceding time in advance based on a tendency of a fluctuation in the gas pressure obtained by performing a molding cycle a plurality of times.

19. The method for molding a foam molded product according to claim 14,
wherein the gas injection port in the heating cylinder is provided with a resin pressure gauge configured to detect a resin pressure, and
wherein the method further comprises determining the specified delay time in advance based on a tendency of a fluctuation in the resin pressure obtained by performing a molding cycle a plurality of times.

20. The method for molding a foam molded product according to claim 15,
wherein the gas injection port in the heating cylinder is provided with a resin pressure gauge configured to detect a resin pressure, and
wherein the method further comprises determining the specified preceding time in advance based on a tendency of a fluctuation in the resin pressure obtained by performing a molding cycle a plurality of times.

21. The method for molding a foam molded product according to claim 13,
wherein the gas flow path of the gas supply device is provided with a gas pressure gauge configured to detect a gas pressure, and
wherein the closing of the valve mechanism is performed when the detected gas pressure reaches an appropriate gas pressure range set in advance or after a specified holding time since the detected gas pressure reaches the appropriate gas pressure range.

22. The method for molding a foam molded product according to claim 13,
wherein the gas injection port in the heating cylinder is provided with a resin pressure gauge configured to detect a resin pressure, and
wherein the closing of the valve mechanism is performed when the detected resin pressure reaches an appropriate resin pressure range set in advance or after a specified holding time since the detected resin pressure reaches the appropriate resin pressure range.

23. The method for molding a foam molded product according to claim 15,
wherein the gas flow path of the gas supply device is provided with a gas pressure gauge configured to detect a gas pressure, and
wherein the method further comprises adjusting the specified preceding time for each molding cycle based on the gas pressure detected at the start of the measuring step.
